(19) United States
(12) Patent Application Publication
(10) Pub. No.: US 2025/0376821 A1
(43) Pub. Date: Dec. 11, 2025

(54) MOUNTING SYSTEM AND CONTROLLER FOR VEHICLE MOUNTED ACCESSORY

(71) Applicant: Meyer Products LLC, Mayfield, OH (US)

(72) Inventor: Louis M. Orazem, Chardon, OH (US)

(21) Appl. No.: 19/205,338

(22) Filed: May 12, 2025

Related U.S. Application Data
(60) Provisional application No. 63/656,443, filed on Jun. 5, 2024.

(51) Int. Cl. E01H 5/06; B60R 16/02; B60R 16/023

(52) U.S. Cl. CPC E01H 5/066; B60R 16/0207; B60R 16/0231

(57) ABSTRACT

A system is for mounting or dismounting an accessory, such as a snow plow, from a vehicle. The system includes a hydraulic unit having multiple actuators, a motor for driving the hydraulic unit, a first controller for controlling a first subset of the actuators of the hydraulic unit during mounting or dismounting of the accessory and a second controller for controlling a second subset of the actuators of the hydraulic unit during use of the accessory. The first controller is powered independently of the second controller and is operable to power the motor and control actuators from the first subset to mount or dismount the accessory from the vehicle without input from the second controller.

### CROSS-REFERENCE TO RELATED APPLICATIONS

This application claims the benefit of U.S. Provisional Patent Application No. 63/656,443, filed Jun. 5, 2024, the entire contents of which are hereby incorporated by reference.

### FIELD OF THE INVENTION

The present invention relates to a mounting device and controller for attaching an accessory, such as a plow mechanism as might be associated with a snowplow blade, or a rotary broom mechanism, or other such heavy accessories, to the front end of a vehicle, such as a pickup truck. More particularly, the present invention relates to a self-aligning, hydraulically powered mounting device that enables one to easily mount and dismount an implement to a vehicle using a controller to control a hydraulic unit.

### BACKGROUND

Many vehicle owners have plow blades attached to the front ends of their vehicles. Often, a plow blade is removably or detachably mounted to the front end of a vehicle so that the plow blade can be selectively detached from the vehicle and stored when not in use and selectively attached from the vehicle and stored when not in use and selectively attached or reattached to the vehicle when the vehicle operator anticipates that plowing may be desired.

Assemblies and mounting devices for removably attaching a plow blade to the front end of a vehicle are well known. Typically, these assemblies include a frame assembly semi-permanently connected to the vehicle or, more specifically, the chassis of the vehicle. “Semi-permanently connected,” as used herein, refers to a connection that does not have to be broken each time the plow blade is detached from the vehicle. The plow blade is often connected to a blade assembly. The blade assembly is selectively engaged or connected to the frame assembly for mounting the blade to the vehicle. A lift assembly is often provided for lifting or positioning the relatively heavy plow blade relative to the vehicle.

In modern accessory systems, a controller is often provided to users and made available within a vehicle cabin. Such a controller often controls a hydraulic unit that facilitates the mounting and dismounting of the accessory, as well as various controls made available to a user during use of the accessory. In the context of a plow, such a controller may be used for mounting and dismounting, but may further be used for directional control (left or right movement) as well as lifting and lowering of a plow. In the context of plows having additional movable components, such as adjustable wings, such components may similarly be controllable from an in-cabin controller.

Because the hydraulic unit receives commands from and is typically powered by way of the controller, the in-cabin controller typically must provide some command in order to mount or dismount the plow. When dismounting such a plow, the in-cabin controller typically must first be set to a dismount or “float” mode so as to allow the plow to be removed from the frame assembly. However, this requires that during a dismounting process, a user return to the in-cabin controller, which is inconvenient and time consuming. This further requires that the in-cabin controller remain electrically connected to the accessory during dismounting. This further prevents the dismounting of the accessory in the event of some disruption or malfunction with respect to the in-cabin controller.

There is a need for a system and method for dismounting such an accessory without relying on the in-cabin controller. There is a further need for such a system and method that can continue to function even when the in-cabin controller is disconnected or fails.

### SUMMARY

In some embodiments, a system is provided for mounting or dismounting an accessory, such as a snow plow, from a vehicle. The system includes a hydraulic unit having a plurality of actuators, a motor for driving the hydraulic unit, a first controller for controlling a first subset of the actuators of the hydraulic unit during mounting or dismounting of the accessory and a second controller for controlling a second subset of the actuators of the hydraulic unit during use of the accessory. The first controller is powered independently of the second controller and is operable to power the motor and control actuators from the first subset to mount or dismount the accessory from the vehicle without input from the second controller.

In some embodiments, the first controller is a toggle switch switchable between mounting and dismounting positions. In some embodiments, the accessory is a vehicle mounted plow.

In some embodiments, the second controller is mounted inside a vehicle cabin, such that at least some features of the accessory are controllable from within the vehicle cabin. In some such embodiments, the second subset includes at least one actuator associated with directional control not included in the first subset, such that the accessory can be angled or tilted directionally from the second controller but not the first controller. In some such embodiments, the first subset includes at least one actuator associated with dismounting not included in the second subset, such that the accessory cannot be dismounted from the second controller without access to the first controller.

In some embodiments, the first controller is fixed to or incorporated into the accessory and the second controller is removably linked to the accessory by way of a first wire harness. In some such embodiments, the first controller is provided with power from a secondary wire harness independent of the first wire harness.

In some embodiments, the first controller functions to mount or dismount the accessory when the second controller is disconnected from the accessory. In some such embodiments, the first and second controllers are each independently powered, such that the first controller provides power to the motor in the absence of the second controller.

In some embodiments, the first controller is powered from a battery associated with the vehicle on which the accessory is to be mounted. In some such embodiments, the second controller is powered from an accessory connection in a cabin of the vehicle. In some such embodiments, the accessory connection is associated with ignition for the vehicle.

In some embodiments in which the first controller is powered from a battery associated with the vehicle, the second controller is powered from the battery associated with the vehicle in parallel with the first controller such that each of the first and second controller can independently provide power to the motor of the hydraulic unit.

In some embodiments, the first controller toggles between a first configuration in which the first controller provides power to a first combination of actuators associated with mounting the accessory, including an actuator associated with the motor and a second configuration in which the first controller provides power to the first combination of actuators and at least one additional actuator.

In some embodiments, each actuator is a solenoid.

In some embodiments, the system includes an attachment structure secured to a frame of the vehicle to which the accessory mounts and a mount assembly for mating with the attachment structure. The mount assembly is then positioned relative to the attachment structure prior to actuation, and the first controller pivots a first portion of the accessory relative to the mount assembly.

In some such embodiments, the pivoting of a first portion of the accessory relative to the mount assembly is implemented by the extension or collapsing of a cylinder of the hydraulic unit.

### BRIEF DESCRIPTION OF THE DRAWINGS

FIG. 1 is a rear perspective view of a plow mounting device showing a frame assembly capable of being semi-permanently connected to a vehicle and a blade assembly having a plow blade and a grasping assembly in a closed position releasably connected to the frame assembly in accordance with a preferred embodiment of the present invention.

FIG. 2 is a front perspective of the plow mounting device of FIG. 1 showing the blade assembly.

FIG. 3 is a rear perspective view of the plow mounting device of FIG. 1 showing the grasping assembly of the blade assembly in an open position and is connected from the frame assembly.

FIG. 4 is a side elevational view of the plow mounting device of FIG. 1.

FIG. 5 is a side elevational view of the plow mounting device of FIG. 3.

FIG. 6 is a rear elevational view of the plow mounting device of FIG. 1.

FIG. 7 is an alternative embodiment of a plow mounting device prior to mounting.

FIG. 8 is the plow mounting device of FIG. 7 during engagement.

FIG. 9 is a hydraulic unit for use with the plow of FIG. 1.

FIG. 10 is a table illustrating a combination of solenoids activated in the hydraulic unit and the resulting actions implemented by the system.

FIG. 11 illustrates the use of a hydraulic switch to mount the plow of FIG. 1.

FIG. 12 illustrates the use of the hydraulic switch to dismount the plow of FIG. 1.

FIG. 13 illustrates the connection of wire harnesses when using the system described herein.

FIG. 14 schematically shows wiring associated with the hydraulic switch of FIG. 9.

FIG. 15 schematically shows wiring associated with two discrete controllers.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

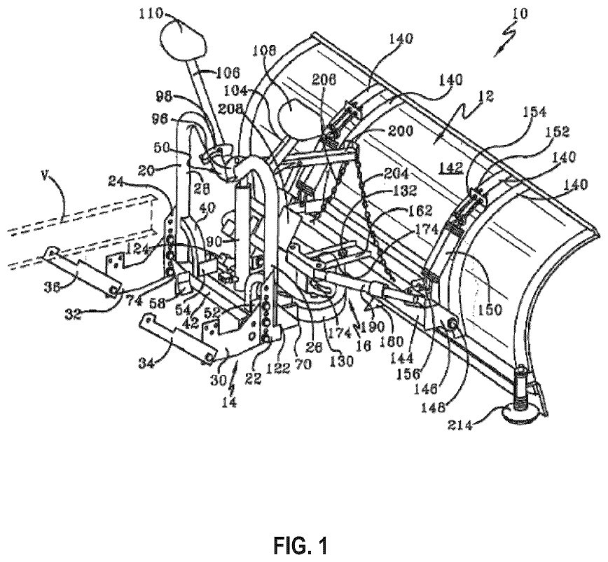

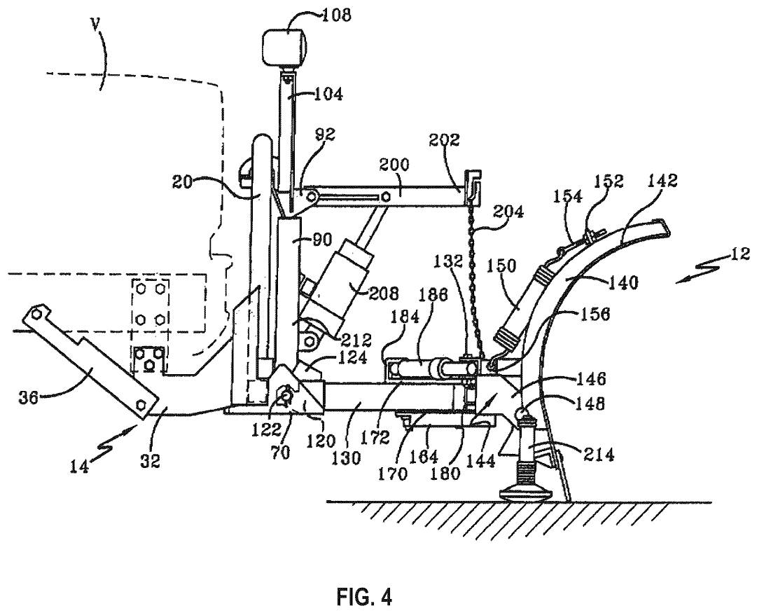

FIG. 1 shows a plow mounting device or assembly generally designated by reference numeral 10. The plow mounting assembly 10 allows a conventional plow blade 12 to be removably or detachably mounted to the front of an associated vehicle V (partially shown in FIG. 4). The invention enables the plow blade 12 to be selectively attached to the vehicle when it is anticipated that it might be desirable to use the plow blade 12 and selectively detached from the vehicle and stored when it is anticipated that the plow blade will not be needed.

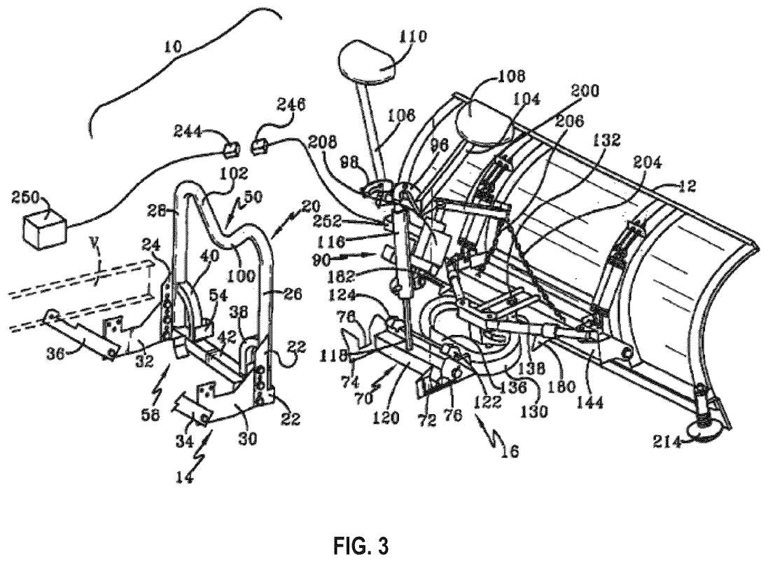

With reference to FIGS. 1-6, and more specifically FIG. 3, the plow mounting assembly 10 generally includes a frame assembly 14 adapted to be semi-permanently connected or mounted directly on the front end of the vehicle V. The frame assembly 14 is a generally non-interfering structure when attached to the front of the vehicle, i.e., the frame assembly 14 does not interfere with functions of the vehicle. At least a portion of the frame assembly 14 can be coated with vinyl or chrome. Further, the frame assembly 14 can serve as a brush guard with its lower horizontal portion 42 and upper portion 50 when attached to the vehicle and the plow blade 12 is not mounted thereto.

The plow mounting assembly 10 further includes a blade or lift assembly 16 that carries the plow blade 12. As will be described in more detail below, the blade assembly 16 is selectively engageable or connectable to the frame assembly 14. Thus, when the frame assembly 14 is semi-permanently connected to the vehicle and the blade assembly 16 carries the plow blade 12, engagement between the blade assembly 16 and the frame assembly 14 serves to mount the plow blade 12 to the front of the vehicle.

More specifically, the frame assembly 14 includes a frame member 20 that, in the preferred embodiment, is shaped like the letter “M” and is oriented in a generally upright position. While the “M” shape is the preferred shape, other shapes are capable of carrying out the purposes of the invention. For example, a “V” shaped frame could be used and is considered within the scope of the present invention. A “V” shaped frame could be configured without vertical portions making up the “M” shaped frame, of the preferred embodiment. Further, equivalent structures having only a single inclined or sloped surface (as opposed to the two inclined or sloped surfaces of the “M” shaped frame member 20) could also be made to work as equivalents.

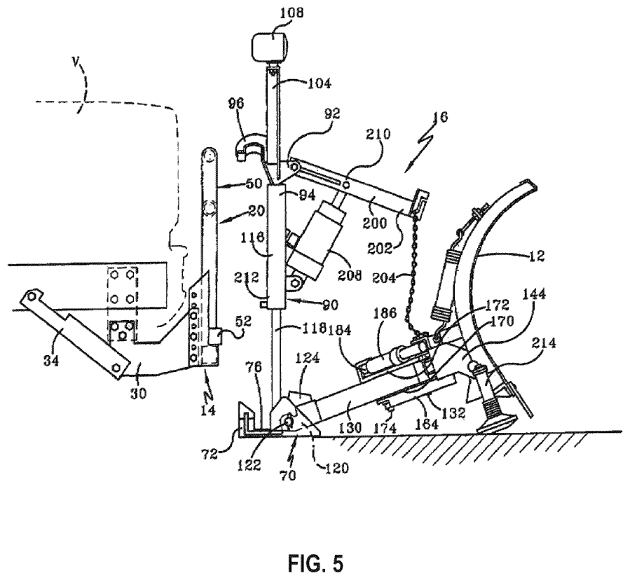

With reference to FIGS. 3 and 5, a pair of flange members 22, 24 extend from vertical portions 26, 28 of the M-shaped frame 20. A pair of arms 30, 32 having holes therethrough are connected, respectively, to each of the flange members 22, 24. The arms 30, 32 extend perpendicularly relative to the frame 20. Arm extensions 34, 36 are pivotally connected to the arms 30, 32 at the distal ends thereof. The arms 30, 32 and arm extensions 34, 36 are used to semi-permanently mount the frame assembly 12 to the vehicle V. The frame assembly 14 further includes reinforcing members 38,40 connecting the vertical portions 26, 28 to a generally lower horizontal portion 42 of the M-shaped frame 20. The particular structure shown provides excellent ground clearance. More particularly, the height of the arms 30, 32 is less than about six (6) inches, whereby a ground clearance of the associated vehicle is lowered by about six (6) inches or less due to the presence of the frame assembly.

An upper or M-shaped portion 50 of the frame 20 spaced from the lower portion 42 provides an aligning means or centering shape for aligning or centering the blade assembly 16 on the frame assembly 14 as will be described in more detail below. The frame 20 includes a pair of contact members or stops 52, 54 for engaging a portion of the blade assembly 16. The contact members 52, 54 extend perpendicularly relative to the frame 20 and in a direction opposite the arms 30, 32. The contact members 52, 54 are positioned immediately above the horizontal portion 42 and each extends generally from a respective one of the reinforcing members 38, 40.

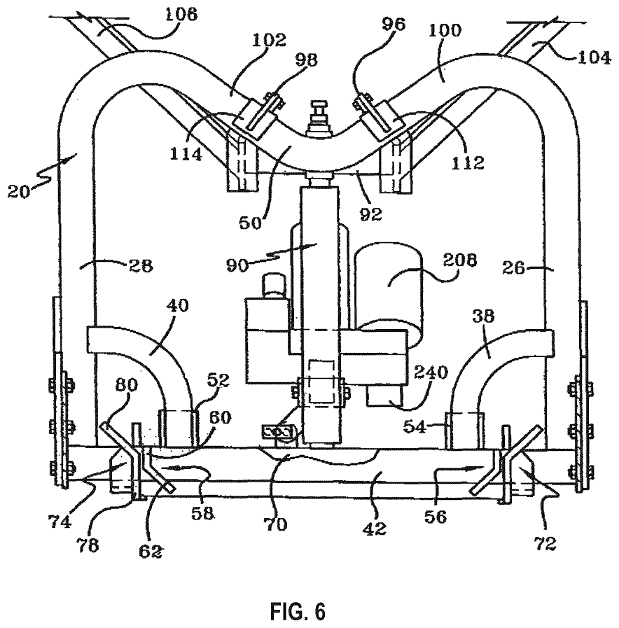

With reference to FIGS. 1 and 6, lower centering guides 56, 58 are provided on the lower horizontal portion 42 on a side thereof opposite the contact members 52, 54. Each of the lower centering guides 56, 58, also referred to herein as guiding members, includes a vertical portion 60 and an angled portion 62. The centering guides 56, 58 function to align and center the blade assembly 16 relative to the frame assembly 14 when the blade assembly 16 is being connected to or engaged with the frame assembly 14 and the blade assembly 16 is slightly misaligned or uncentered relative to the frame assembly 14. The contact members 52, 54 function to maintain or limit the position of the blade assembly 16 relative to the frame assembly 14 when the two components 14,16 are connected.

With reference to FIGS. 3 and 5, the blade assembly 16 includes a lower engaging member 70 that abuts or contacts the frame assembly 14 when the blade assembly 16 is connected thereto. The engaging member 70 includes a first clasp or fastener that, in the illustrated embodiment, is a pair of upwardly extending clamps or hooks 72, 74 spaced apart from one another. The hooks 72, 74 each define a recess 76 appropriately shaped to engage and securely receive the lower horizontal portion 42 of the frame assembly 14. With reference to FIG. 6, the spacing between the hooks 72, 74 is such that when the horizontal portion 42 is received in the recesses 76 the hooks 72, 74 are slightly outside the centering guides 56, 58. Each of the hooks 72, 74 includes a vertical portion 78 and an angled portion 80. The angled portion 80 is approximately the same as or at an angle that substantially matches the angle of the angled portions 62 of the centering guides 56, 58. The positioning between the guides 56, 58 and the hooks 72, 74 and the angled portions 62, 80 function to center and align the blade assembly 16 relative to the frame assembly 14 when the frame assembly 14 is connected or being connected to the blade assembly 16.

With reference back to FIGS. 3 and 5, the blade assembly 16 further includes a grasping assembly for removably connecting to the frame assembly 14. The grasping assembly includes the lower engaging member 70, a telescoping cylinder 90 and an upper engaging member 92. The telescoping cylinder 90 extends vertically upward from the lower engaging member 70. The cylinder 90 is oriented in a position that is generally parallel to the upright frame 20 when the blade assembly 16 is connected to the frame assembly 14. The cylinder 90 is movable between a closed or collapsed position and an open or expandable position. In the preferred embodiment, the cylinder 90 is a conventional hydraulic cylinder actuated by a conventional hydraulic pump (shown schematically as a rectangle and labeled 240 in FIG. 6). The cylinder 90 can also be a conventional self-locking cylinder that locks in the open position or the closed position when the cylinder 90 is in one of these positions and the hydraulics of the cylinder are not actuated. Alternatively, the cylinder 90 could be any other actuator such as, for example, an acme screw with an electric motor.

The upper engaging member 92 is located at or adjacent an upper end 94 of the cylinder 90. The upper engaging member 92 includes a second clasp or fastener that, in the illustrated embodiment, is a pair of opposed, downwardly extending clamps or hooks 96, 98 spaced apart from one another and angled to substantially match first and second angled sections 100, 102 of the upper portion 50. The sections 100, 102 together form a V-shape that generally centers the blade assembly 16 relative to the frame assembly 14. More specifically, the angled sections 100, 102 are angled between about five (5) degrees and about eighty-five (85) degrees relative to their respective vertical portions 26, 28 or generally horizontal plane. The hooks 96, 98 are appropriately positioned to engage the first and second angled sections 100, 102 when the blade assembly 16 is connected to the frame assembly 14.

The upper engaging member 92 can additionally include arms 104, 106 for supporting lights 108, 110 at distal ends thereof. The lights 108, 110 can be directed or positioned to illuminate an area beyond the plow blade 12 particularly when the plow blade 12 obstructs the lights of the vehicle V. With reference to FIG. 9, the hooks 96,98 can include protective inserts or pads 112, 114 to prevent or reduce scratching of the M-shaped member 20 when connecting the blade assembly 16 to the frame assembly 14. In the preferred embodiment, the pads 112, 114 are coated with a low friction material such as TEFLON™.

Thus, with reference back to FIGS. 3 and 5, the cylinder 90 extends between the upper hooks 96, 98 and the lower hooks 72, 74. More specifically, the cylinder 90 includes an elongated tubular portion 116 depending from the upper engaging member 92 and an elongated cylindrical portion 118 telescopingly received in the tubular portion 116 and extending from the lower engaging member 70. The cylindrical portion 118 extends from the tubular portion 116 when the grasping assembly is in the open position and is retracted within the tubular portion 116 when the grasping assembly is in the closed position.

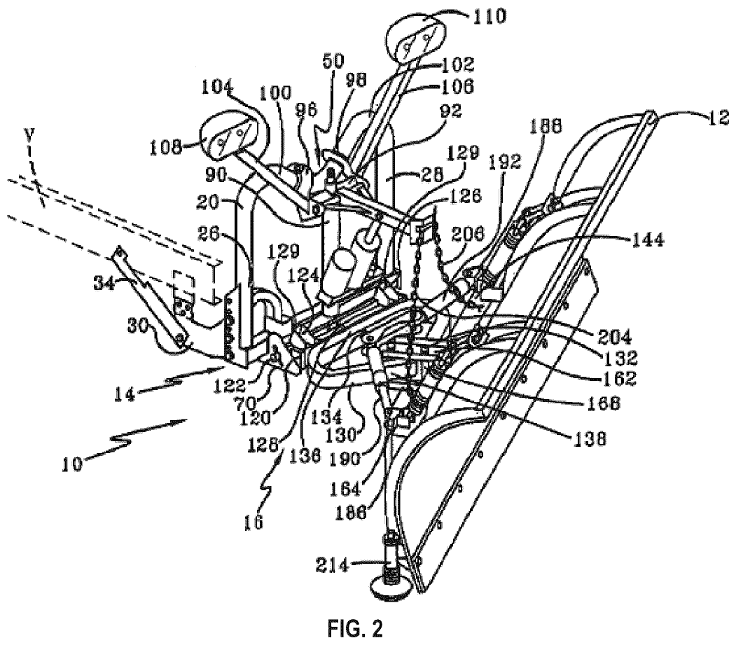

With additional reference to FIG. 2, the blade assembly 16 further includes a lift bar 120 that is pivotally connected to the lower engaging member 70 by a first pivot pin 122 that is generally parallel to a wheel axis of the vehicle and the width of the vehicle when the blade assembly 16 is connected to the frame assembly 14 on the vehicle V. The first pivot pin 122 includes a grease fitting which extends the useful life of the pivot pin connection. The lift bar 120 is generally oriented in a position parallel relative to the lower engaging member 70. As a result, the lift bar 120 and the plow blade 12 are able to pivot up and down relative to the lower engaging member 70, the front end of the vehicle and/or the ground thereby allowing the plow blade 12 to be raised and lowered relative to the ground.

The lift bar 120 includes a pair of stops 124, 126 adjacent an upper side 128 of the lift bar 120 for limiting pivotal movement of the lift bar 120 relative to the engaging member 120. More specifically, the stops 124, 126 are aligned with the stops or contact members 52, 54 when the blade assembly 16 is connected to the frame assembly 14 and angled surfaces 129 of the stops 124, 126 will abut vertical surfaces of the contact members 52, 54 when the lift bar 120 is pivoted to a predetermined angle relative to the lower engaging assembly 70. The predetermined angle is determined by the angled surfaces 129 of the stops 124, 126 and the distances between the stops 124, 126 and the contact members 52, 54.

A horizontal plow frame member 130 constructed of formed rectangular tubing is rotatably connected to the plow blade 12 by a second pivot pin 132 and to the lift bar 120 by a third pivot pin 134. Like the first pivot pin 122, the second and third pivot pins 132, 134 each include a grease fitting which extends the useful lives of the second and third pivot connections. The third pivot pin 134 is defined along a portion of a longitudinal axis extending along the longitudinal length of the vehicle and allows the frame member 130 to pivot rotatably relative to the lift bar 120. More specifically, the third pivot pin 134 allows the plow blade 12 to rotate about said longitudinal axis for allowing the plow blade 12 to remain generally parallel to the ground.

The frame member 130 is generally tear drop shaped or candy kiss shaped and is oriented generally perpendicularly relative to the frame 20 when the blade assembly 16 is connected to the frame assembly 14. With additional reference to FIG. 3, the frame member 130 includes a rear portion 136 that is substantially flat or straight and positioned adjacent the lift member 120. The rear portion 136 is the portion of the frame member 130 that is rotatably connected to the lift bar 120. Specifically, the rear portion 136 is rotatably connected to the lift bar 120 adjacent a center of the lift bar 120 and the rear portion 136. The frame member 130 further includes a front portion 138, also referred to herein as an apex portion, that is generally pointed and positioned opposite the rear portion 136. Rounded portions connect or extend between the base portion 136 and side portions that form the pointed portion 138. The third pivot pin 134 connecting the frame member 128 to the lift bar 120 allows the plow blade 12 to rotatably pivot and thereby follow the contour of the road.

With reference to FIG. 1, the plow blade 12 includes ribs 140 vertically oriented on a non-plowing surface 142 of the blade 12. With additional reference to FIG. 4, a plow mounting beam 144 is connected to the plow blade 12 and extends horizontally along the surface 142. The beam 144 includes a plurality of flanges 146 that pivotally connect to the ribs 140 with the use of suitable fasteners such as threaded connectors 148. The relatively wide mounting beam 144 provides increased rigidity to the blade assembly 16. Tensioning springs 150 also connect the plow blade 12 to the mounting beam 144. More particularly, the plow blade 12 includes spring mounting flanges 152 positioned above the connections between the ribs 140 and the flanges 146. The spring mounting flanges 152 receive suitable spring mounting or tensioning bolts 154 therethrough that connect to first ends of the springs 150. The second ends of the springs 150 connect to spring mounting flanges 156 formed integrally on the mounting beam 144.

With reference to FIG. 2, the mounting beam 144 is rotatably or pivotally connected to the pointed portion 138 of the frame member 130. More specifically, the mounting beam 144 includes an upper arm 162 and a lower arm 164. The arms 162, 164 extend away from the plow blade 12 in a direction generally perpendicular relative to a longitudinal length of the mounting beam 144. The second pivot pin 132 rotatably connects the arms 162, 164 of the mounting beam 144 to the frame member 130. Specifically, the second pivot pin 132 extends through the upper arm 162, through a sleeve 168 defined in the pointed portion 138 of the frame member 130 and through the lower arm 164 thereby allowing the mounting beam 144 to pivot relative to the frame member 130 which allows the plow blade 12 to be positioned at an angle relative to the front of the vehicle. More specifically, the second pivot pin 132 allows the plow blade 12 to pivot left and right relative to the front end of the vehicle V. The lengths of the upper and lower arms 162, 164 correspond to a maximum pivot angle allowed by the mounting beam 144 and the plow blade 12.

With reference to FIG. 4, a lower guide plate 170 is sandwiched between the sleeve 168 and the lower arm 164. An upper guide member 172 is sandwiched between the sleeve 168 and the upper arm 162. The guide plate 170 and the guide member 172 extend into a center portion of the frame member 130 and remain fixed relative to the frame member 130. A guide pin 174 (see also FIG. 1) also rotatably connects the arms 162, 164 and the frame member 130 at a preselected distance beyond the second pivot pin 132. The pin 174 extends through the arms 162, 164 at a distal location on the arms 162, 164 relative to the second pivot pin 132 and passes through the center portion or interior of the frame member 130. The guide plate 170 and the guide member 172 each include respective slots that receive the second pivot pin 174 therethrough. The slots guide the pivot of the mounting beam 144 relative to the frame member 130 and provide stops or limits to the degree of pivot permitted between the beam 144 and the frame member 130.

Additionally, with reference to FIG. 3, pivoting is limited by stops or protrusions 180, 182 extending from the mounting beam 144. Rubber members or TEFLON™ inserts may be added to or substituted for the stops 180, 182 to cushion the impact caused when the frame member 132 engages one of the stops 180, 182. More specifically, the mounting beam 144 and the plow blade 12 are pivotally movable about the second pivot pin between a first position wherein the mounting beam 144 engages one of the side portions of the frame member 130 and a second position wherein the mounting beam 144 engages the other of the side portions of the frame member 130. In the first position, the stop 180 engages the frame member 130 and in the second position the stop 182 engages the frame member 130. Alternatively, any rubberized member, coating or the like may be used to cushion the engagement between the stops 180, 182 and the frame member 130. The stops 180, 182 limit the amount of angular displacement of the plow blade 12 relative to the frame member 130 which remains parallel with the front of the vehicle to which the plow blade 12 is mounted. Alternatively, the stops could be disposed on the frame member 130.

With reference to FIG. 2, adjacent a side of the guide member 172 that is opposite the pin 174, a channel 184 is defined. A pair of channel members 186, 188 is disposed on the mounting beam 144. The first channel member 186 is at a first position on the mounting beam 144 spaced apart in a first direction from the upper arm 162. The second channel member 188 is at a second position on the mounting beam 144 spaced apart in a second, opposite direction from the upper arm 162. A pair of telescoping cylinders 190, 192 connects the channel members 186, 188 to the channel 184. More specifically, the first cylinder 190 extends between the first channel member 186 and one end of the channel 184. The second cylinder 192 extends between the second channel member 188 and the other end of the channel 184. The first and second cylinders 190, 192 are pivotally connected at their sides to the channel 184 and channel members 186, 188. As is known in the art, the cylinders 190, 192 may be hydraulically driven to pivot the plow blade 12 about the second pivot pin 132.

With reference to FIGS. 1 and 5, a lift arm 200 is pivotally connected to the upper engaging member 92 of the grasping assembly and extends outwardly therefrom in the direction of the plow blade 12. At or near a distal end 202 of the lift bar 200, a pair of chains 204, 206 connect the lift bar 200 to the mounting beam 144. More specifically, the distal end 202 of the lift bar 200 is positioned or extends beyond the second pivot pin 122 and the chains 204, 206 extend downwardly to the beam 144 to maintain the plow blade 12 in a generally horizontal orientation even when the blade 12 is pivoted or angled relative to the frame member 132. A lift unit 208 is connected to the lift arm 200 and the vertical cylinder 90. Specifically, the lift unit 208 pivotally connects to a center portion 210 of the lift arm 200 and pivotally connects to center portion 212 of the vertical cylinder 90. The lift unit 208 is adapted to move the lift arm 200 to thereby move the plow blade 12 up and down, i.e., pivoting about first pivot pin 122. At the top end of the vertical cylinder 90, an adjustment mechanism, such as an adjustment screw, enables the mounting assembly to adjust to differing heights of various vehicles.

With the frame assembly 14 semi-permanently mounted or attached to the vehicle as described above, the blade assembly 16 can be readily connected or mounted to the frame assembly 14 on the vehicle. With reference to FIG. 3, the blade assembly 16 is shown resting on the ground. The vertical cylinder 90 is in the expanded position and, thus, the grasping assembly is in the open position which is required for securing the blade assembly 16 to the frame assembly 14 because the upper and lower hooks are separated from one another a distance sufficient to allow the frame assembly 14 to be moved adjacent the blade assembly 16.

When the frame assembly 16 is resting on the ground with the cylinder 90 in its expanded position, the lift bar 120 contacts and directly rests on the ground and a pair of plow blade supports or shoes 214 also contact and directly rest on the ground. The shoes 214 keep the blade 12 from engagement with the ground and protect the blade 12 while the blade assembly 16 is connected to the frame assembly 14. More specifically, the shoes 214 are positioned adjacent each lateral side edge of the plow blade 12 and adjacent the bottom edge of the plow blade 12. The shoes 214 are positioned to scrape the ground when the blade 12 is mounted to a vehicle to guide the blade along the ground. Further, the shoes 214 are positioned to guide the lateral side edges of the blade 12 along curbs. Additionally, the shoes 214 can be rotatably mounted to spin as they ride along curbs.

Also shown in FIG. 3, are limited electrical connections for operating the inventive method and apparatus. The electrical connections are shown schematically for ease of illustration. More specifically, certain electronics 250 (known to the industry) are mounted on the vehicle and are connected to certain electronics 252 (known to the industry) that are mounted on the blade assembly 16. The electronics 250, 252 are selectively operatively connected and connectable by manually connecting first plug 244 to second plug 246. Through the electrical connections, the cylinder 90 can be operated and/or controlled by a control unit (not shown) located in the cabin of the vehicle V.

To mount or connect the blade assembly 16 to the frame assembly 14, the vehicle with the frame assembly 14 attached thereto drives or moves toward the blade assembly 16 until the frame assembly 14 contacts the blade assembly 16 or is very near to or adjacent the blade assembly 16, i.e., the vehicle pulls forward until the M-shaped frame 20 is positioned or aligned with the recesses 76 of the lower hooks 72, 74 and the recesses of the upper hooks 96, 98. Further, the vertical centerline of the M-shaped frame 20 should be generally aligned or only slightly misaligned relative to the vertical cylinder 90. The grasping assembly may then be moved toward its closed or collapsed position which allows the hooks 72, 74, 96, 98 to capture or grasp the M-shaped frame 20.

As the cylinder 90 is collapsed, the upper hooks 72, 74 engage the angled portions 100, 102 of the M-shaped frame 20. Due to the angled portions 100,102 and the angled orientation of the upper hooks 96, 98, the blade assembly 16 is urged to a centered position relative to the frame assembly 14. Further, as the cylinder 90 is collapsed, the lower hooks 72, 74 engage the lower horizontal portion 42 of the frame assembly 14 and the lower engaging member 70 rises off the ground. More specifically, if the blade assembly 16 is slightly misaligned relative to the frame assembly 14, the angled portions 80 engage the lower centering guides 56, 58 and are urged into a centered position on the frame assembly 14. Thus, when the grasping assembly is in its closed position, i.e., the cylinder 90 is collapsed, the blade assembly 16 is centered and locked to the frame assembly 14 and centrally positioned on the vehicle. Notably, the grasping assembly removably connects to the frame assembly 14 without the use of pins or levers, such as those used in the prior art patents discussed above.

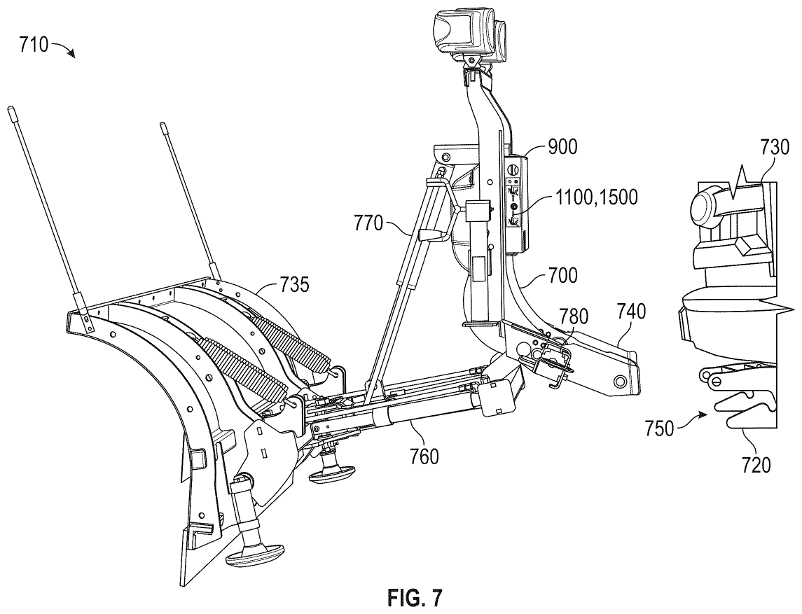

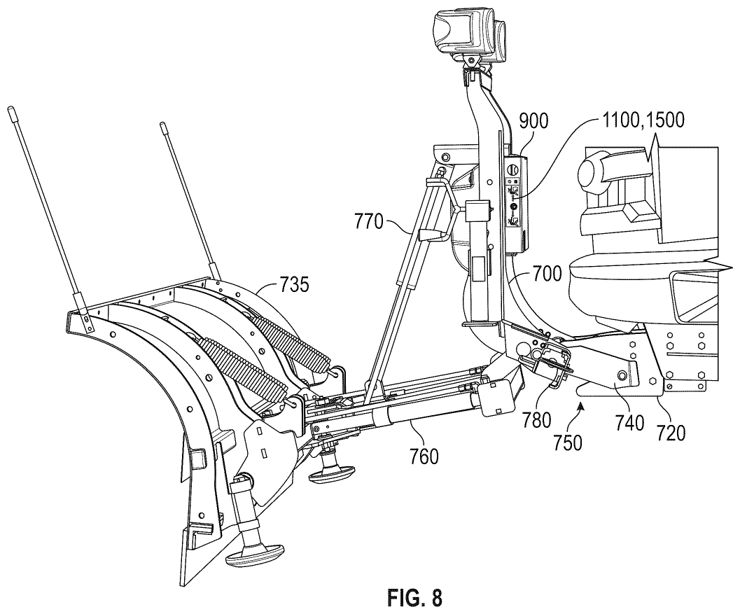

FIG. 7 is an alternative embodiment of an accessory mounting device 700 and system 710 prior to mounting. FIG. 8 is the accessory mounting device 700 and system 710 of FIG. 7 during engagement. As shown, and similar to the embodiment discussed above with respect to FIG. 1, the system 710 includes an attachment structure 720, such as a bracket, secured to a frame of the vehicle 730, such as a pickup truck. The accessory 735, in this case a plow blade similar to the plow blade 12 shown above with respect to the assembly 10 of FIG. 1, then mounts to the attachment structure 720 by way of the mounting device 700. The accessory mounting device 700 includes a mount assembly 740, or mounting structure, for mating with the attachment structure 720.

The mount assembly 740 is typically positioned relative to the attachment structure 720 prior to mounting. This can be, for example, by positioning the accessory 735 on a ground surface and driving the vehicle 730 into position. In the figures shown, the attachment structure 720 is a “clevis” product, and after being located next to each other as shown in FIG. 7, FIG. 8 shows the movement of the vehicle 730 into position such that a segment of the mount assembly 740 is within a jaw 750 of the attachment structure 720.

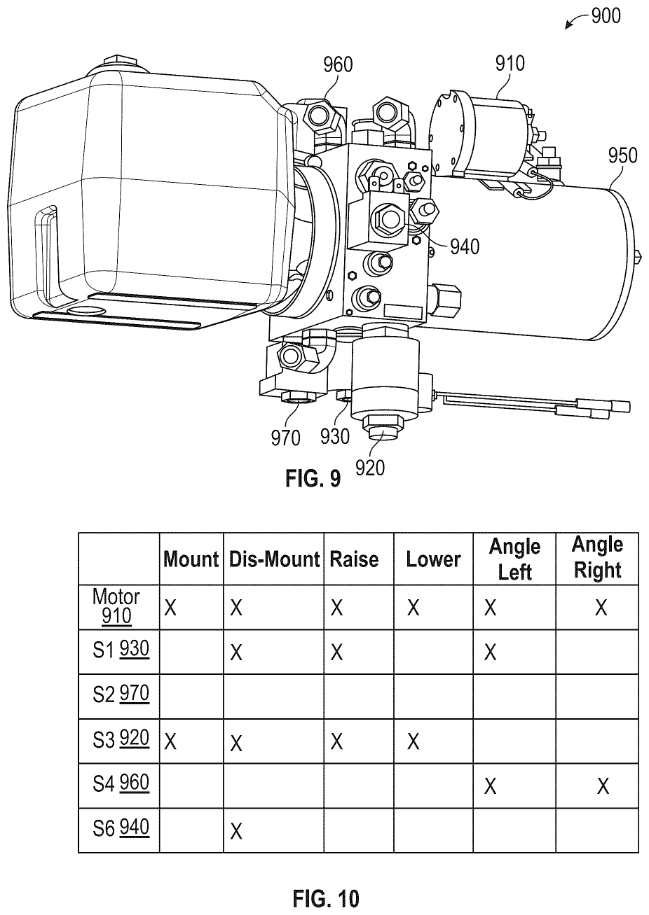

FIG. 9 is a hydraulic unit 900 for use with the accessory 735, mounting device 700, and system 710 of FIG. 7. FIG. 10 is a table illustrating a combination of solenoids energized in the hydraulic unit and the resulting actions implemented by the system. As shown in FIG. 10, energizing various combinations of solenoids in the hydraulic unit 900 can allow for different functions. In the context of mounting and dismounting the accessory 735, the actuation of the motor solenoid 910 and combinations of the S3 solenoid 920, the S1 solenoid 930, and the S6 solenoid 940 results in the pivoting of a first portion 760 of the accessory 735 relative to the mount assembly 740. This would be by extending or collapsing of a lift cylinder 770.

In the embodiment shown in FIGS. 9 and 10, the accessory 735 is ultimately retained by the attachment structure 720 by way of pins 780 that are spring loaded and snap into place when the accessory mounting device 700 is properly positioned. Accordingly, once the accessory mounting device 700 is properly positioned relative to the attachment structure 720, a user can actuate the motor solenoid 910 and the S3 solenoid 920 to implement a mounting routine. The combination of the motor solenoid 910 and the S3 solenoid 920 results in the extension of the lift cylinder 770, thereby pivoting the mount assembly 740 relative to the rest of the accessory 735, including the first portion 760, thereby lifting or pivoting the mount assembly 740 into place. Once the mount assembly 740 structure is properly located, the pins 780 snap into place, and the cylinder 770 can be used to lift or lower the accessory 735 relative to the mount assembly 740 and the attaching structure 720. Accordingly, a plow 735 mounted in this way can be moved using the same lift cylinder 770 initially used to mount the plow. Once the plow 735 is fully supported by the vehicle 730 and lifted, any stand used to support the plow in position can be removed.

In order to dismount the accessory, any stand that has been removed is typically put back into position and the pins 780 are released. Solenoids may then be energized in order to lower the plow 735 back onto the jack stand. In the embodiment shown, the dismounting process includes the energizing of the motor solenoid 910 as well as the S1 930, S3 920, and S6 940 solenoids. This may be the energizing of the S3 solenoid 920, which is often designated with green, discussed above, as well as the S1 solenoid 930, often designated as black as well as a relief solenoid, here S6 940.

The system 710 described may then be used to mount or dismount an accessory 735, in this case a plow, from a vehicle 730. The system 710 includes a hydraulic unit 900, such as that shown in FIG. 9 and a motor 950 for driving the hydraulic unit, shown integrated into the hydraulic unit in FIG. 9. The hydraulic unit 900 further includes a plurality of actuators 910, 920, 930, 940. In the embodiment shown, the actuators 910, 920, 930, 940 take the form of solenoids which, when taken in combination, actuate different functions by way of the hydraulic unit 900.

A first controller 1500 is then provided for controlling a first subset of the actuators 910, 920, 930, 940 of the hydraulic unit 900 during dismounting of the accessory, and a second controller 1510 is then provided for controlling a second subset of the actuators 910, 920, 930, 960 of the hydraulic unit 900 during use of the accessory.

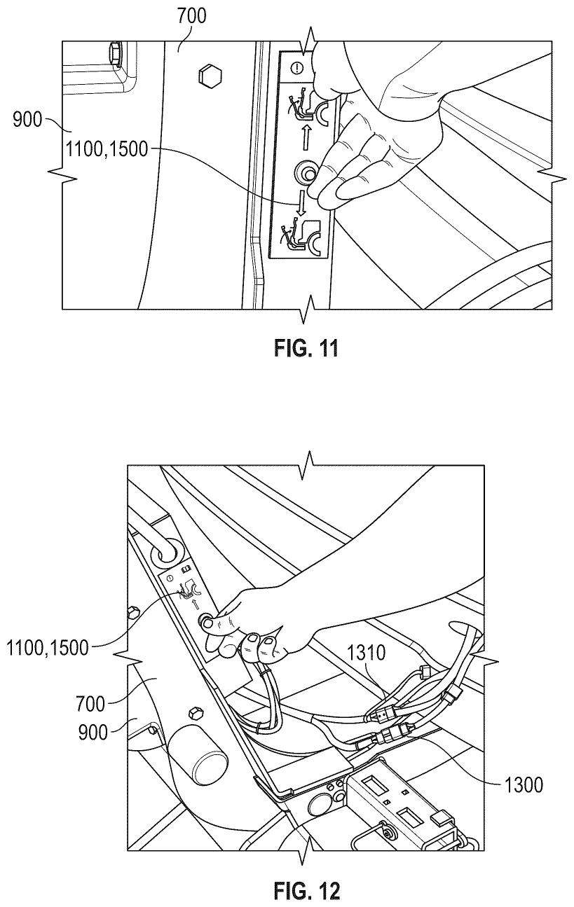

For example, FIG. 11 illustrates the use of a hydraulic switch 1100 to mount the accessory 735 of FIG. 7 and FIG. 12 illustrates the use of the hydraulic switch 1100 to dismount the accessory of FIG. 7. The hydraulic switch 1100 may be the first controller 1500, and may be able to control solenoids 910, 920, 930, 940 involved in mounting and dismounting the accessory 735. As noted above the mounting and dismounting processes involve energizing different coordinated sets of solenoids. The toggle switch 1100 shown can be used to implement either of these combinations, and can therefore control the S1 (930), S3 (920), S6 (940) and motor (910) solenoids.

The first controller 1500, or toggle switch 1100, may then be located on the accessory 735 or mounting device 700 or itself. For example, the switch 1100 may be mounted on a side surface of or on a mounting structure of the mounting device 700 associated with a plow 735.

The second controller 1510 may be located at a different location than the first controller 1500. For example, it may be a controller 1510 located within a cabin of the vehicle 730 on which the accessory 735 is mounted. The second controller 1510 may then be configured to control actuators 910, 920, 930, 940, 960 of the hydraulic unit 900 used during use of the accessory 735, such as directional controls. In FIG. 10, such directional controls may then require use of the S4 actuator 960 which may use a blue wire. Such an S4 actuator 960 may not be controllable from the first controller 1500. In this way, at least some features of the accessory 735 are controllable from within the vehicle cabin 730. Further, the second subset of actuators may include the S4 actuator 960 associated with directional control which is not included in the first subset. The accessory can then be angled or tilted directionally from the second controller 1510, but not from the first controller 1500.

In some embodiments, the first subset may include at least one actuator 940 associated with dismounting not included in the second subset, such that the accessory 735 cannot be dismounted from the second controller 1510 without access to the first controller 1500. However, many embodiments, including that shown, may allow for the dismounting from the second controller 1510.

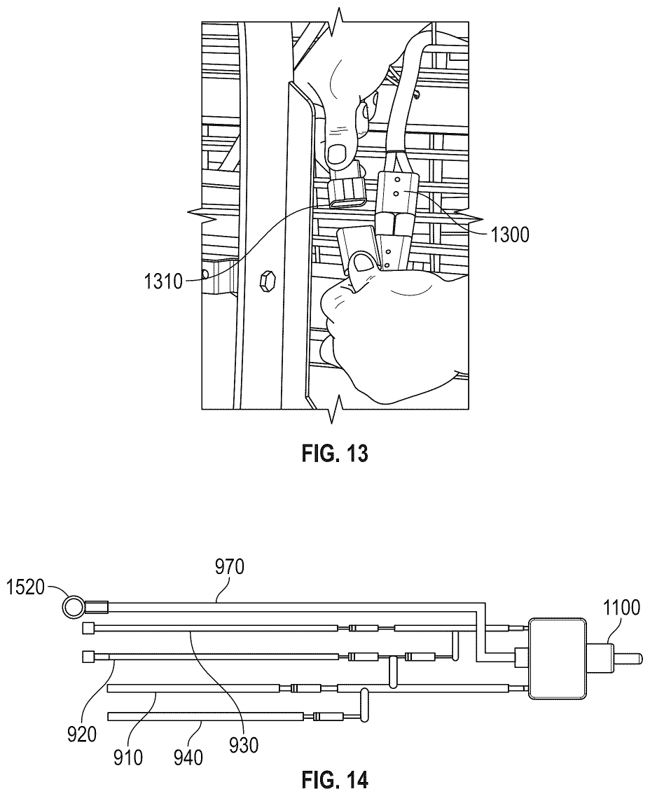

FIG. 13 illustrates the connection of wire harnesses 1300, 1310 when using the system 710 described herein. The first controller 1500 may be powered independently of the second controller 1510, and the first controller 1500 may be operable to power the motor 950 and control actuators 910, 920, 930, 940 from the first subset to mount or dismount the accessory 735 from the vehicle 730 without input from the second controller 1500. Accordingly, each of the first controller 1500 and the second controller 1510 may be independently provided with corresponding power sources 1520, 530 and may be independently linked to the accessory 735 and the corresponding hydraulic unit 900. Accordingly, two discrete wire harnesses 1300, 1310 may be used, with a first wire harness 1300 used for providing power to the first controller 1500 and the hydraulic unit 900 and a second wire harness 1310 used to provide power to the second controller 1510 and the accessory 735. The second wire harness 1310 may further provide additional wires to provide control signals from the second controller 1510 to the accessory 735.

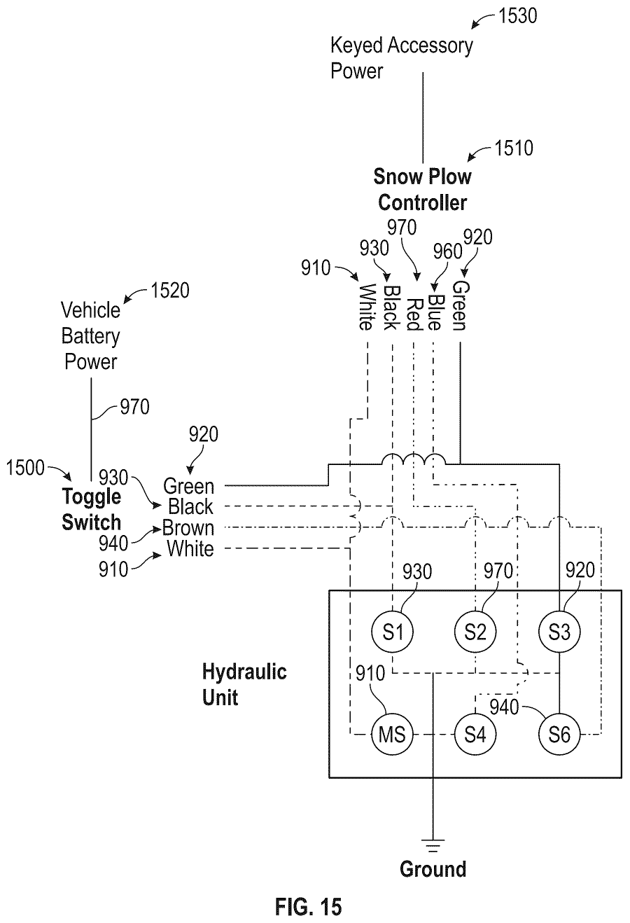

FIG. 14 schematically shows wiring associated with the hydraulic switch 1100 of FIG. 11. FIG. 15 schematically shows wiring associated with two discrete controllers 1500, 1510.

As noted above, the first controller 1500 may be the hydraulic switch 1100 mounted directly on the accessory 735 and therefore may be hardwired to the first subset of actuators 910, 920, 930, 940. The second controller 1510 may then be removably linked to the accessory by way of the second wire harness 1310 discussed above. The first controller 1500 may then be provided with power from the first wire harness 1300 shown by way of a power supply wire 970, which may often be shown in red. The hydraulic unit 900 may be provided with power either by way of the hydraulic switch 1100 or separately by way of the same wire harness 1300.

Because the first controller 1500 is independently provided with power 970, the first controller may function to mount or dismount the accessory when the second controller 1510 is disconnected from the accessory. Because the controllers 1500, 1510 are independently powered and correspond to independent power supplies 1520, 1530, the first controller 1500 may then provide power to the motor 950 in the absence of the second controller 1510.

The first controller 1500 may then be powered from a battery 1520 associated with the vehicle 730 on which the accessory is to be mounted. For example, the first controller 1500 may be linked directly to the vehicle battery 1520, as shown in FIG. 14. The second controller 1510 may then be powered from an accessory connection 1530 in the cabin of the vehicle 730 as shown in FIG. 15. Such an accessory connection 1530 may be associated with ignition for the vehicle 730. Accordingly, the second controller 1510 may become active and may be used to power the accessory only when the vehicle 730 itself is turned on.

Similarly, both the first controller 1500 and the second controller 1510 may be independently provided with power from the battery 1520 associated with the vehicle 730. Providing power to both controllers 1500, 1510 in parallel allows each controller to independently provide power to the motor 950 of the hydraulic unit 900. Where such power from the second controller 1510 is mediated through the accessory connection 1530, the second controller 1510 may function only when the vehicle 730 is turned on. In some embodiments, the first power supply is then a vehicle battery 1520 while the second power supply 1530 is a vehicle alternator.

In this scenario, if the vehicle 730 is turned off before removing the accessory, the second controller 1510 may not be usable to dismount the accessory, but the first controller 1500 may still provide power to implement such a dismount.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A system for mounting or dismounting an accessory from a vehicle comprising:
a hydraulic unit comprising a plurality of actuators;
a motor for driving the hydraulic unit;
a first controller for controlling a first subset of the actuators of the hydraulic unit during mounting or dismounting of the accessory; and
a second controller for controlling a second subset of the actuators of the hydraulic unit during use of the accessory,
wherein the first controller is powered independently of the second controller and is operable to power the motor and control actuators from the first subset to mount or dismount the accessory from the vehicle without input from the second controller.

2. The system of claim 1 wherein the first controller is a toggle switch switchable between mounting and dismounting positions.

3. The system of claim 1, wherein the accessory is a vehicle mounted plow.

4. The system of claim 1, wherein the second controller is mounted inside a vehicle cabin, such that at least some features of the accessory are controllable from within the vehicle cabin.

5. The system of claim 4, wherein the second subset includes at least one actuator associated with directional control not included in the first subset, such that the accessory can be angled or tilted directionally from the second controller but not the first controller.

6. The system of claim 5, wherein the first subset includes at least one actuator associated with dismounting not included in the second subset, such that the accessory cannot be dismounted from the second controller without access to the first controller.

7. The system of claim 1, wherein the first controller is fixed to or incorporated into the accessory and the second controller is removably linked to the accessory by way of a first wire harness.

8. The system of claim 7, wherein the first controller is provided with power from a secondary wire harness independent of the first wire harness.

9. The system of claim 1, wherein the first controller functions to mount or dismount the accessory when the second controller is disconnected from the accessory.

10. The system of claim 9, wherein the first and second controllers are each independently powered, such that the first controller provides power to the motor in the absence of the second controller.

11. The system of claim 1, wherein the first controller is powered from a battery associated with the vehicle on which the accessory is to be mounted.

12. The system of claim 11, wherein the second controller is powered from an accessory connection in a cabin of the vehicle.

13. The system of claim 12, wherein the accessory connection is associated with ignition for the vehicle.

14. The system of claim 11, wherein the second controller is powered from the battery associated with the vehicle in parallel with the first controller such that each of the first and second controller can independently provide power to the motor of the hydraulic unit.

15. The system of claim 1, wherein the first controller toggles between a first configuration in which the first controller provides power to a first combination of actuators associated with mounting the accessory, including an actuator associated with the motor and a second configuration in which the first controller provides power to the first combination of actuators and at least one additional actuator.

16. The system of claim 1, wherein each actuator is a solenoid.

17. The system of claim 1 further comprising an attachment structure secured to a frame of the vehicle to which the accessory mounts and a mount assembly for mating with the attachment structure, and wherein the mount assembly is positioned relative to the attachment structure prior to actuation, and wherein the first controller pivots a first portion of the accessory relative to the mount assembly.

18. The system of claim 17. wherein the pivoting of a first portion of the accessory relative to the mount assembly is implemented by the extension or collapsing of a cylinder of the hydraulic unit.
